(19) United States
(12) Patent Application Publication
(10) Pub. No.: US 2007/0183352 A1
(43) Pub. Date: Aug. 9, 2007

(54) Methods and apparatus for providing a shared server system for a platform of multiple wireless communication devices

(76) Inventors: Mustafa Muhammad, Portland, OR (US); Ron Nevo, Portland, OR (US)

Correspondence Address: INTEL CORPORATION;C/O INTELLEVATE, LLC, P.O. BOX 52050, MINNEAPOLIS, MN, 55402, US

(21) Appl. No.: 11/350,529

(22) Filed: Feb. 8, 2006

(51) Int. Cl. H04H 1/00

(52) U.S. Cl. 370/312; 370/395.5

(57) ABSTRACT

Embodiments of methods and apparatus for providing a shared server system for a platform of multiple wireless communication devices are generally described herein. Other embodiments may be described and claimed.

### TECHNICAL FIELD

The present disclosure relates generally to wireless communication systems, and more particularly, to methods and apparatus for providing a shared server system for a platform of multiple wireless communication devices.

### BACKGROUND

As wireless communication becomes more and more popular at offices, homes, schools, etc., different wireless technologies and applications may work in tandem to meet the demand for computing and communications at anytime and/or anywhere. For example, a variety of wireless communication networks may co-exist to provide a wireless environment with more computing and/or communication capability, greater mobility, and/or eventually seamless roaming.

In particular, wireless personal area networks (WPANs) may offer fast, short-distance connectivity within a relatively small space such as an office workspace or a room within a home. Wireless local area networks (WLANs) may provide broader range than WPANs within office buildings, homes, schools, etc. Wireless metropolitan area networks (WMANs) may cover a greater distance than WLANs by connecting, for example, buildings to one another over a broader geographic area. Wireless wide area networks (WWANs) may provide the broadest range as such networks are widely deployed in cellular infrastructure. Although each of the above-mentioned wireless communication networks may support different usages, co-existence among these networks may provide a more robust environment with anytime and anywhere connectivity.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of an example wireless communication platform.

FIG. 3 is a block diagram representation of an example shared server system.

FIG. 4 is a flow diagram representation of one manner in which the example shared server system of FIG. 3 may be configured.

FIG. 5 is a block diagram representation of an example processor system that may be used to implement the example wireless communication platform of FIG. 2.

### DETAILED DESCRIPTION

In general, methods and apparatus for providing a shared server system for a platform of multiple wireless communication devices are described herein. The methods and apparatus described herein are not limited in this regard.

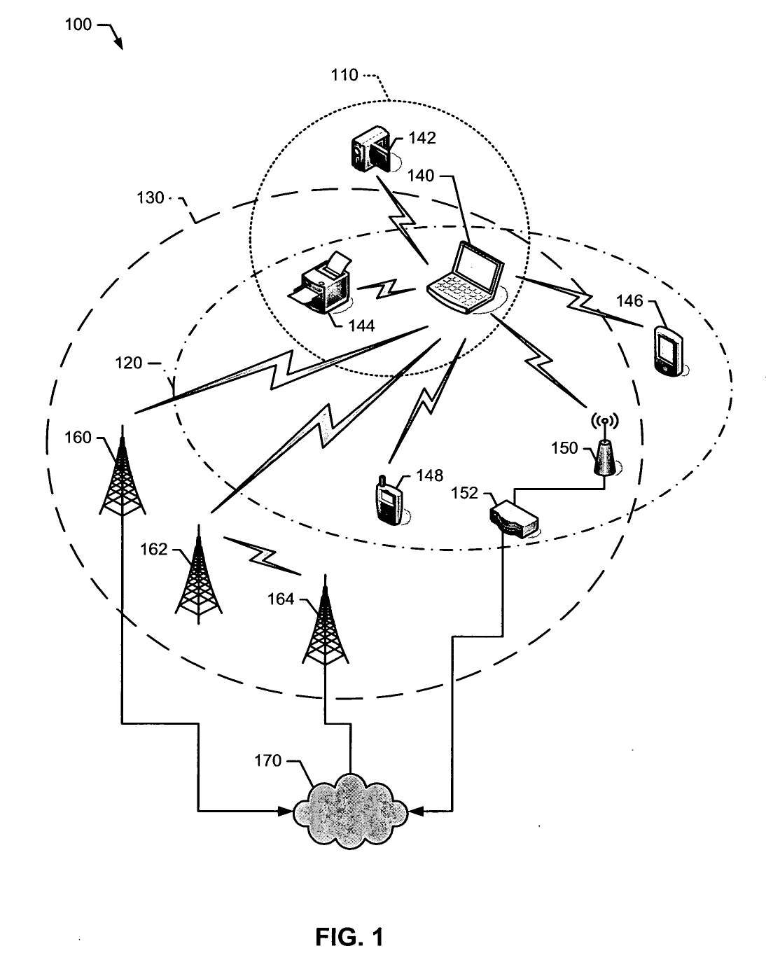

Referring to FIG. 1, an example wireless communication system 100 may include one or more wireless communication networks, generally shown as 110, 120, and 130. In particular, the wireless communication system 100 may include a wireless personal area network (WPAN) 110, a wireless local area network (WLAN) 120, and a wireless metropolitan area network (WMAN) 130. Although FIG. 1 depicts three wireless communication networks, the wireless communication system 100 may include additional or fewer wireless communication networks. For example, the wireless communication networks 100 may include additional WPANs, WLANs, and/or WMANs. The methods and apparatus described herein are not limited in this regard.

The wireless communication system 100 may also include one or more subscriber stations, generally shown as 140, 142, 144, 146, and 148. For example, the subscriber stations 140, 142, 144, 146, and 148 may include wireless electronic devices such as a desktop computer, a laptop computer, a handheld computer, a tablet computer, a cellular telephone, a pager, an audio and/or video player (e.g., an MP3 player or a DVD player), a gaming device, a video camera, a digital camera, a navigation device (e.g., a GPS device), a wireless peripheral (e.g., a printer, a scanner, a headset, a keyboard, a mouse, etc.), a medical device (e.g., a heart rate monitor, a blood pressure monitor, etc.), and/or other suitable fixed, portable, or mobile electronic devices. Although FIG. 1 depicts five subscriber stations, the wireless communication system 100 may include more or less subscriber stations.

The subscriber stations 140, 142, 144, 146, and 148 may use a variety of modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate via wireless links. In one example, the laptop computer 140 may operate in accordance with suitable wireless communication protocols that require very low power such as Bluetooth®, ultra-wide band (UWB), and/or radio frequency identification (RFID) to implement the WPAN 110. In particular, the laptop computer 140 may communicate with devices associated with the WPAN 110 such as the video camera 142 and/or the printer 144 via wireless links.

In another example, the laptop computer 140 may use direct sequence spread spectrum (DSSS) modulation and/or frequency hopping spread spectrum (FHSS) modulation to implement the WLAN 120 (e.g., the 802.11 family of standards developed by the Institute of Electrical and Electronic Engineers (IEEE) and/or variations and evolutions of these standards). For example, the laptop computer 140 may communicate with devices associated with the WLAN 120 such as the printer 144, the handheld computer 146 and/or the smart phone 148 via wireless links. The laptop computer 140 may also communicate with an access point (AP) 150 via a wireless link. The AP 150 may be operatively coupled to a router 152 as described in further detail below. Alternatively, the AP 150 and the router 152 may be integrated into a single device (e.g., a wireless router).

The laptop computer 140 may use OFDM modulation to transmit large amounts of digital data by splitting a radio frequency signal into multiple small sub-signals, which in turn, are transmitted simultaneously at different frequencies. In particular, the laptop computer 140 may use OFDM modulation to implement the WMAN 130. For example, the laptop computer 140 may operate in accordance with the 802.16 family of standards developed by IEEE to provide for fixed, portable, and/or mobile broadband wireless access (BWA) networks (e.g., the IEEE std. 802.16, published 2004) to communicate with base stations, generally shown as 160, 162, and 164, via wireless link(s).

Although some of the above examples are described above with respect to standards developed by IEEE, the methods and apparatus disclosed herein are readily applicable to many specifications and/or standards developed by other special interest groups and/or standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), etc.). The methods and apparatus described herein are not limited in this regard.

The WLAN 120 and WMAN 130 may be operatively coupled to a common public or private network 170 such as the Internet, a telephone network (e.g., public switched telephone network (PSTN)), a local area network (LAN), a cable network, and/or another wireless network via connection to an Ethernet, a digital subscriber line (DSL), a telephone line, a coaxial cable, and/or any wireless connection, etc. In one example, the WLAN 120 may be operatively coupled to the common public or private network 170 via the AP 150 and/or the router 152. In another example, the WMAN 130 may be operatively coupled to the common public or private network 170 via the base station(s) 160, 162, and/or 164.

The wireless communication system 100 may include other suitable wireless communication networks. For example, the wireless communication system 100 may include a wireless wide area network (WWAN) (not shown). The laptop computer 140 may operate in accordance with other wireless communication protocols to support a WWAN. In particular, these wireless communication protocols may be based on analog, digital, and/or dual-mode communication system technologies such as Global System for Mobile Communications (GSM) technology, Wideband Code Division Multiple Access (WCDMA) technology, General Packet Radio Services (GPRS) technology, Enhanced Data GSM Environment (EDGE) technology, Universal Mobile Telecommunications System (UMTS) technology, standards based on these technologies, variations and evolutions of these standards, and/or other suitable wireless communication standards. Although FIG. 1 depicts a WPAN, a WLAN, and a WMAN, the wireless communication system 100 may include other combinations of WPANs, WLANs, WMANs, and/or WWANs. The methods and apparatus described herein are not limited in this regard.

The wireless communication system 100 may include other WPAN, WLAN, WMAN, and/or WWAN devices (not shown) such as network interface devices and peripherals (e.g., network interface cards (NICs)), access points (APs), redistribution points, end points, gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

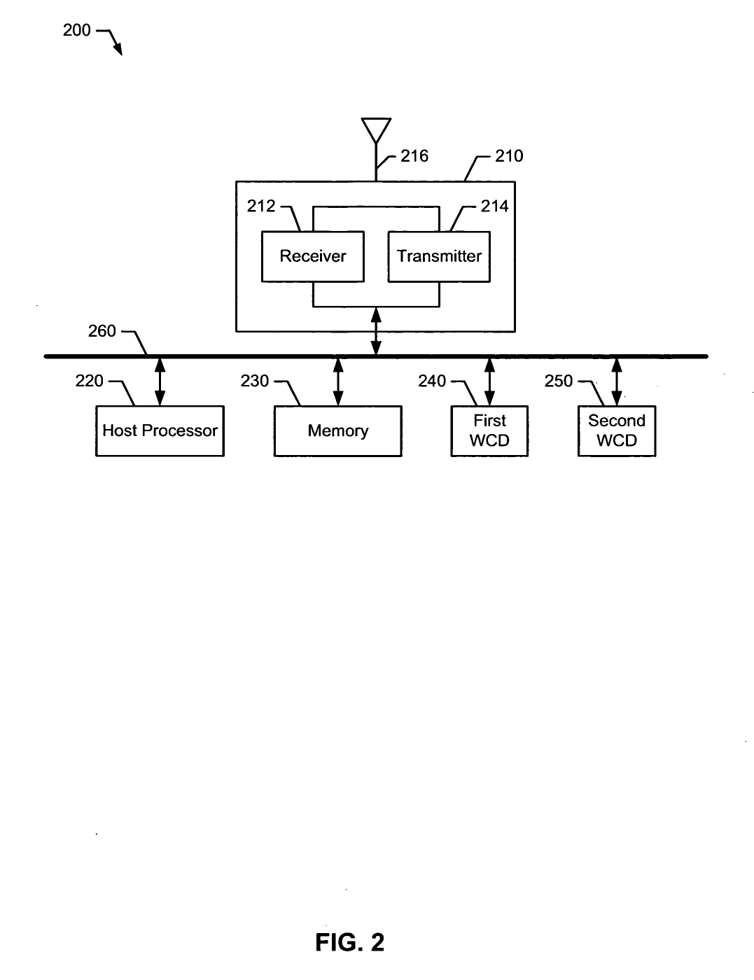

Referring to FIG. 2, for example, a wireless communication platform 200 may include a network interface device (NID) 210, a host processor 220, and a memory 230. The wireless communication platform 200 may also include two or more wireless communication devices (WCDs), generally shown as 240 and 250. The NID 210, the host processor 220, the memory 230, and/or the WCDs 240 and 250 may be operatively coupled to each other via a bus 260. While FIG. 2 depicts components of the wireless communication platform 200 coupling to each other via a bus 260, these components may be operatively coupled to each other via other suitable direct or indirect connections (e.g., a point-to-point connection or a point-to-multiple point connection). Further, although the components shown in FIG. 2 are depicted as separate blocks within the wireless communication platform 200, the functions performed by some of these blocks may be integrated within a single semiconductor circuit or may be implemented using two or more separate integrated circuits. For example, although the receiver 212 and the transmitter 214 are depicted as separate blocks within the NID 210, the receiver 212 may be integrated into the transmitter 214 (e.g., a transceiver). In addition, while FIG. 2 depicts two WCDs, the wireless communication platform 200 may include additional WCDs. The methods and apparatus described herein are not limited in this regard.

The NID 210 may include a receiver 212, a transmitter 214, and an antenna 216. The wireless communication platform 200 may receive and/or transmit data via the receiver 212 and the transmitter 214, respectively. The antenna 216 may include one or more directional or omni-directional antennas such as dipole antennas, monopole antennas, patch antennas, loop antennas, microstrip antennas, and/or other types of antennas suitable for transmission of radio frequency (RF) signals. Although FIG. 2 depicts a single antenna, the wireless communication platform 200 may include additional antennas. For example, the wireless communication platform 200 may include a plurality of antennas to implement a multiple-input-multiple-output (MIMO) system.

The first WCD 240 may provide communication services associated with a first wireless communication network (e.g., the WPAN 110 of FIG. 1) and the second WCD 250 may provide communication services associated with a second wireless communication network (e.g., the WLAN 120 of FIG. 1). In one example, the first wireless communication network may operate based on Bluetooth® technology, and the second wireless communication network may operate based on Wi-Fi technology. Accordingly, following the above example, the first WCD 240 may communicate based on Bluetooth® technology whereas the second WCD 250 may communicate based on Wi-Fi technology. The methods and apparatus described herein are not limited in this regard.

Briefly, Bluetooth® technology may provide a low-power, high-throughput wireless connectivity within a relatively short range (e.g., less than 30 feet). In particular, Bluetooth® technology may allow a wireless device to connect with one or more computing and/or communication peripherals. In one example, Bluetooth® technology may allow a computer to connect and exchange information with a printer via a wireless link. In another example, Bluetooth® technology may allow a cellular telephone to communicate with a headset via a wireless link. Bluetooth® technology may operate in a frequency range starting at 2.402 gigahertz (GHz) and ending at 2.480 GHz. The 802.15 family of standards were developed by IEEE to provide for WPANs (e.g., the IEEE std. 802.15.1, published Jun. 14, 2002). The Bluetooth Special Interest Group facilitates deployment of WPANs based on the 802.15 standards. The methods and apparatus described herein are not limited in this regard.

Wi-Fi technology may provide high-speed wireless connectivity within a range of a wireless access point (e.g., a hotspot) in different locations including homes, offices, cafes, hotels, airports, etc. In particular, Wi-Fi technology may allow a wireless device to connect to a local area network without physically plugging the wireless device into the network when the wireless device is within a range of wireless access point (e.g., within 150 feet indoor or 300 feet outdoors). In one example, Wi-Fi technology may offer high-speed Internet access and/or Voice over Internet Protocol (VoIP) service connection to wireless devices. Wi-Fi technology may operate in a frequency range starting at 2.4 GHz and ending at 2.4835 GHz. The 802.11 family of standards were developed by IEEE to provide for WLANs (e.g., the IEEE std. 802.11a, published 1999; the IEEE std. 802.11b, published 1999; the IEEE std. 802.11g, published 2003). The Wi-Fi Alliance facilitates the deployment of WLANs based on the 802.11 standards. In particular, the Wi-Fi Alliance ensures the compatibility and inter-operability of WLAN equipment. For convenience, the terms “802.11” and “Wi-Fi” may be used interchangeably throughout this disclosure to refer to the IEEE 802.11 suite of air interface standards. The methods and apparatus described herein are not limited in this regard.

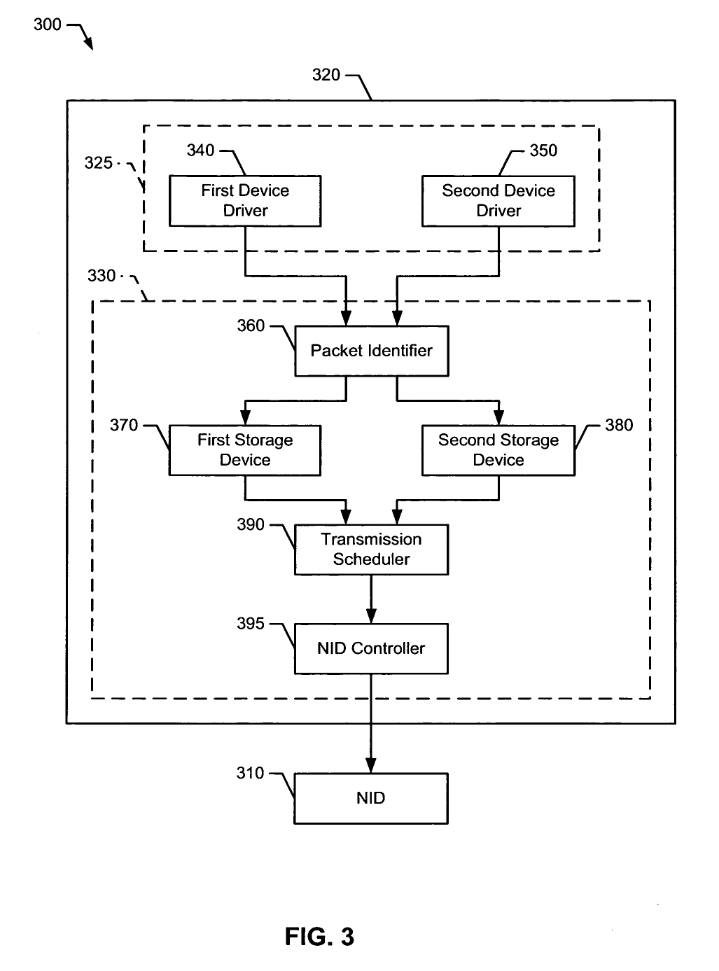

The host processor 220 may include a host operating system (OS) that provides an independent device driver for each of the WCDs 240 and 250. The WCDs 240 and 250, however, may share resources of the wireless communication platform 200 (e.g., direct memory access (DMA) channel, host input/output interface, wireless channels, data buffers, etc.). In one example, the first WCD 240 may acquire ownership of a particular shared resource, perform one or more I/O operations via the shared resource, and then release the shared resource. When trying to acquire for the shared resource, the first WCD 240 may prevent or block the second WCD 250 from using the shared resource. Alternatively, the first WCD 240 may wait for the second WCD 250 to finish using the shared resource before acquiring ownership. The second WCD 250 may operate in a similar manner as described above. Without a shared server system as described herein (e.g., the shared server system 300 of FIG. 3) to coordinate one or more resources of the platform 200 (i.e., shared resources), one of the WCDs 240 and 250 may monopolize one or more shared resources.

In the example of FIG. 3, a shared server system 300 may include a NID 310 and a host processor 320. For example, the NID 310 may be the NID 210 of FIG. 2 as described above. The NID 310 may be operatively coupled to the host processor 320 to communicate data.

The host processor 320 may include an operating system (OS) 325 and a shared server 330. The OS 325 may include two or more device drivers, generally shown as 340 and 350. In one example, the first device driver 340 may be associated with a first WCD (e.g., the first WCD 240 of FIG. 2) and the second device driver 350 may be associated with a second WCD (e.g., the second WCD 250 of FIG. 2). Accordingly, the first and second device drivers 340 and 350 may operate in accordance with different wireless communication protocols. In one example, the first device driver 340 may operate based on Bluetooth® technology (e.g., IEEE std. 802.15.x) and the second device driver 350 may operate based on Wi-Fi technology (e.g., IEEE std. 802.11x). The methods and apparatus described herein are not limited in this regard.

In general, the shared server 330 may facilitate shared resources of the shared server system 300 between the first and second device drivers 340 and 350 to optimize data throughput of the shared server system 300. The shared server 330 may include a packet identifier 360, and two or more storage devices, generally shown as 370 and 380. In particular, the packet identifier 360 may determine where to store a packet received by the shared server 330. For example, the packet identifier 360 may be and/or include a queue mapping table to determine whether to map a packet to the first storage device 370 or the second storage device 380. Each of the storage devices 370 and 380 may be associated with one of the device drivers 340 and 350. In one example, the first storage device 370 may be associated with the first device driver 340 and the second storage device 380 may be associated with the second device driver 350. Each of the first and second storage devices 370 and 380 may include a plurality of queues and/or buffers. Each of the plurality of queues may correspond to packets of a traffic type and/or a traffic priority. In one example, each of the first and second storage devices 370 and 380 may include a first queue for control data and a second queue for user data as described in detail below. The methods and apparatus described herein are not limited this regard.

The shared server 330 may include a transmission scheduler 390 and a NID controller 395. The transmission scheduler 390 may be operatively coupled to the first and second storage devices 370 and 380. Based on traffic types and/or traffic priorities, the transmission scheduler 390 may schedule the packets stored in the first and second storage devices 370 and 380 for transmission via the NID 310. In one example, control data may have a higher priority than user data. Accordingly, the transmission scheduler 390 may schedule for packets of control data to be transmitted before packets of user data.

In another example, the first storage device 370 may have a queue for control data (e.g., Queue A) and a queue for user data (e.g., Queue B), and the second storage device 380 may also have a queue for control data (e.g., Queue C) and a queue for user data (e.g., Queue D). In one priority scheme, for example, Queue A may have first priority, Queue C may have second priority, Queue B may have third priority, and Queue D may have last priority. Based on the above-mentioned priority scheme, the transmission scheduler 390 may schedule for packets from Queue A to be transmitted prior to packets from Queue C, which may be transmitted prior to packets from Queue B. Packets from Queue D may be transmitted after packets from Queues A, B, and C are transmitted. The transmission scheduler 390 may be configured to operate based on other suitable transmission schedules and/or priority schemes. The methods and apparatus described herein are not limited in this regard.

The NID controller 395 may be operatively coupled to the transmission scheduler 390 and the NID 310. The NID controller 395 may control the NID 310 to conserve power of the shared server system 300. In particular, the NID controller 395 may monitor one or more conditions associated with the first and/or second storage devices 370 and 380 to determine whether to turn on or off the NID 310. In one example, the NID controller 395 may monitor the first and second storage devices 370 and 380 to determine whether the first and second storage devices 370 and 380 are empty. If the first and second storage devices 370 and 380 are empty, the NID controller 395 may turn off the NID 310 (e.g., a power save mode). In another example, the transmission scheduler 390 may inform the NID controller 395 that the transmission scheduler 390 does not any traffic queued for transmission. Accordingly, the NID controller 395 may turn off the NID 310.

By centralizing the control of the NID 310 to the NID controller 395, the shared server system 300 may reduce packet transmission latency and increase data throughput. In particular, the NID controller 395 may control the NID 310 based on the collective need of the first and second device drivers 370 and 380. Without removing control of the NID 310 from independent device drivers such as the first and second device drivers 340 and 350, the NID 310 may be unnecessarily switched on and off as the first and second device drivers 340 and 350 may independently control the NID 310 based on the individual needs of the first and second device drivers 340 and 350. The methods and apparatus described herein are not limited in this regard.

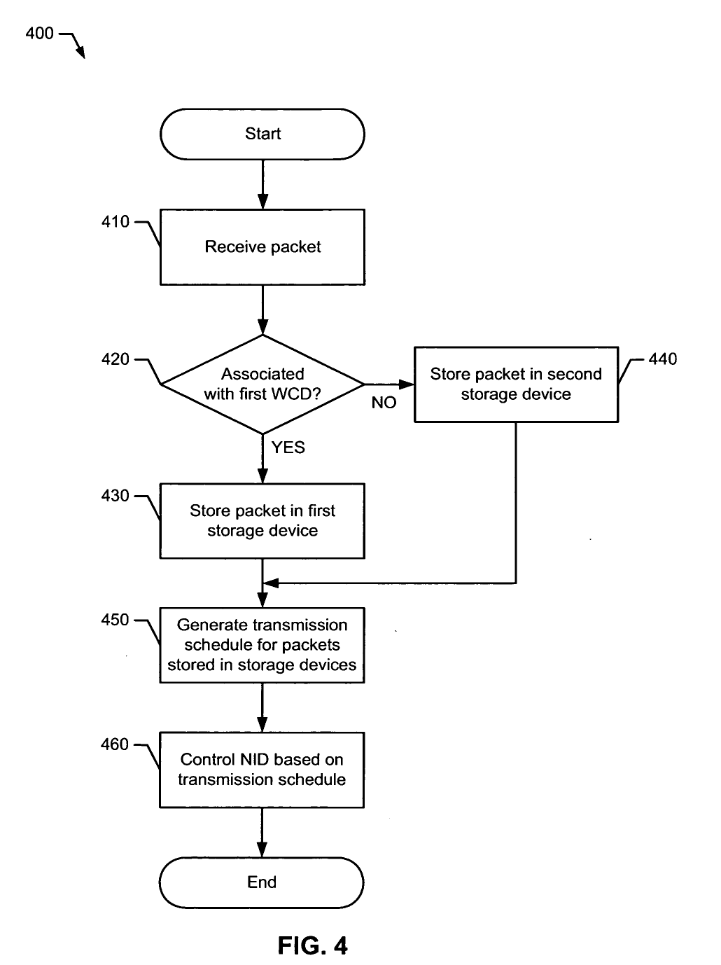

FIG. 4 depicts one manner in which wireless communication devices may be configured to provide the example shared server system of FIG. 3. The example process 400 of FIG. 4 may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium.

Further, although a particular order of actions is illustrated in FIG. 4, these actions may be performed in other temporal sequences. Again, the example process 400 is merely provided and described in conjunction with the apparatus of FIG. 3 as an example of one way to provide a shared server system.

In the example of FIG. 4, the process 400 may begin with the shared server 330 receiving a packet from the OS 325 (block 410). In particular, the shared server 330 may associate the packet with either the first device driver 340 or the second device driver 350. Accordingly, the shared server 330 (e.g., via the packet identifier 360) may map the packet to a corresponding storage device (e.g., the first storage device 370 or the second storage device 380 of FIG. 3). In one example, the packet identifier 360 may determine whether the packet is associated with the first device driver 340 (block 420). For example, the packet identifier 360 may be a queue mapping table. If the packet is associated with the first device driver 340, the packet identifier 360 may store the packet in the first storage device 370 (block 430). Otherwise at block 420, if the packet is associated with the second device driver 350, the packet identifier 360 may store the packet in the second storage device 380 (block 440). As described in detail above in connection with FIG. 3, each of the first and second storage devices 370 and 380 may include a plurality of queues and/or buffers. Each of the plurality of queues may correspond to packets of a traffic type and/or a traffic priority. In one example, each of the first and second storage devices 370 and 380 may include a first queue for control data and a second queue for user data.

To optimize use of available resources, the transmission scheduler 390 may generate a transmission schedule for packets stored in the first and second storage devices 370 and 380 based on the traffic type and/or the traffic priority of the packets (block 450). In particular, the transmission scheduler 390 may establish an order in which the NID controller 395 may transmit the packets stored in the first and second storage devices 370 and 380. In one example, the transmission scheduler 390 may establish a schedule to transmit control data stored in the first and second storage devices 370 and 380 prior to user data stored in the first and second storage devices 370 and 380. In addition or alternatively, the transmission scheduler 390 may define the schedule to transmit the control data of the first storage device 370 prior to the control data of the second storage device 380 or vice versa.

Based on the collective transmission schedule, the NID controller 395 may control the NID 310 (e.g., toggle on/off) (block 460). Instead of allowing either the first device driver 340 or the second device driver 350 to arbitrarily control shared resources, the NID controller 395 may control the NID 310 based on conditions of the first and second storage devices 370 and 380 to reduce packet transmission latency and/or increase data throughput. To conserve power, for example, the NID controller 395 may turn off the NID 310 if the first and second storage devices 370 and 380 are empty (e.g., the power save mode). Accordingly, the NID controller 395 may turn on the NID 310 or keep the NID 310 turned on if either the first storage device 370 or the second storage device 380 includes one or more packets for transmission. The methods and apparatus described herein are not limited in this regard.

Although the above examples describe two wireless communication devices, the methods and apparatus described herein may include three or more wireless communication devices. Further, while the above examples describe a WPAN device and a WLAN device within the wireless communication platform 200 of FIG. 2, the methods and apparatus described herein may include other wireless communication devices that may operate in accordance with other suitable types of wireless communication networks and/or include other combinations of wireless communication devices. In one example, the wireless communication platform 200 may include a wireless communication device for a WWAN as an additional wireless communication device or a substitute wireless communication device. In particular, the wireless communication platform 200 may include a wireless communication device associated with a WLAN (e.g., based on Wi-Fi technology) and a wireless communication device associated with a WWAN (e.g., based on WiMAX technology). In another example, the wireless communication platform 200 may include a WPAN device, a WPAN device, and a WMAN device. The methods and apparatus described herein are not limited in this regard.

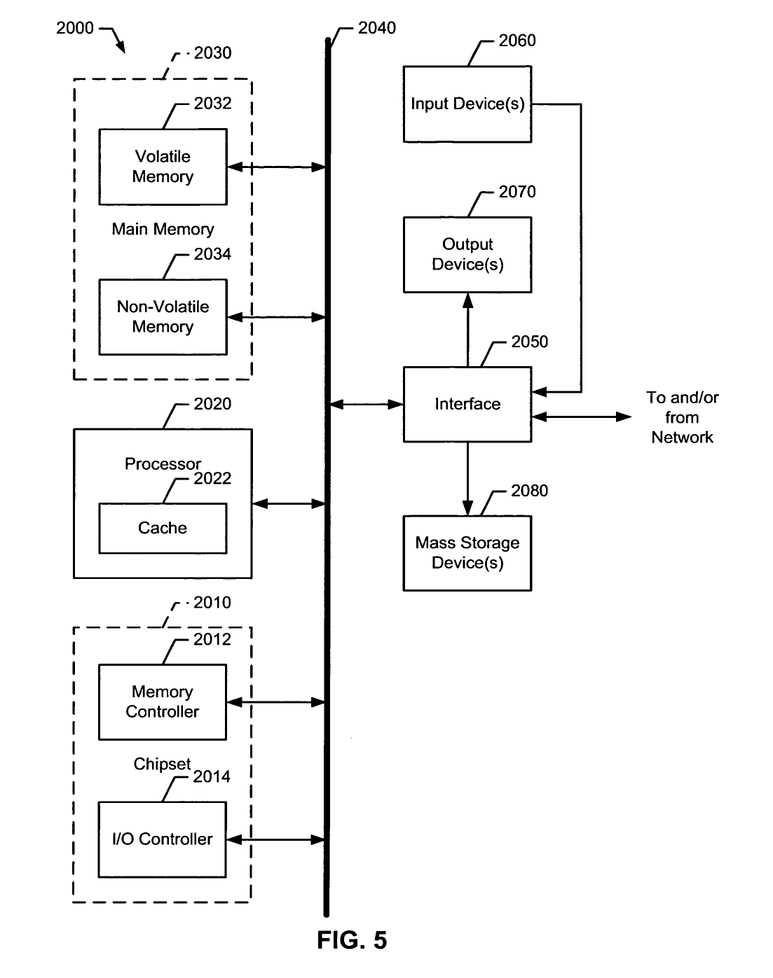

FIG. 5 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 5 may include a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WPAN components, WLAN components, WMAN components, WWAN components, and/or other suitable processing components. For example, the processor 2020 may be implemented using one or more of the Intel® Core™ technology, Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 5 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
associating one or more packets from a first device driver or a second device driver with at least one of a first storage device or a second storage device, the first and second device drivers operating in accordance with different wireless communication protocols and sharing resources of a platform, the first storage device being associated with the first device driver, and the second storage device being associated with the second device driver; and
scheduling transmission of the one or more packets via a network interface device of the platform.

2. A method as defined in claim 1, wherein associating the one or more packets comprises associating a packet from a device driver operating in accordance with a wireless communication protocol associated with at least one of a wireless personal area network, a wireless local area network, a wireless metropolitan area network, or a wireless wide area network.

3. A method as defined in claim 1, wherein associating the one or more packets comprises mapping each of the one or more packets to at least one of the first storage device or the second storage device based on a queue mapping table.

4. A method as defined in claim 1, wherein associating the one or more packets comprises mapping each of the one or more packets to a queue based on at least one of a traffic type or a traffic priority.

5. A method as defined in claim 1, wherein scheduling the transmission of the one or more packets comprises scheduling the transmission of each of the one or more packets based on at least one of a traffic type or a traffic priority.

6. A method as defined in claim 1 further comprising controlling the network interface device based on a condition associated with at least one of the first storage device or the second storage device.

7. A method as defined in claim 1 further comprising monitoring the first and second storage devices and adjusting the network interface device to a power save mode in response to detecting a condition indicative of the first and second storage devices being empty.

8. An article of manufacture including content, which when accessed, causes a machine to:
identify one or more packets from at least one of a first device driver or a second device driver of a platform, the first and second device drivers operating in accordance with different wireless communication protocols and sharing resources of a platform;
store the one or more packets in at least one of a first storage device or a second storage device, the first storage device being associated with the first device driver and the second storage device being associated with the second device driver; and
generate a schedule to transmit the one or more packets via a network interface device of the platform.

9. An article of manufacture as defined in claim 8, wherein the content, when accessed, causes the machine to store the one or more packets by storing a packet from a device driver operating in accordance with a wireless communication protocol associated with at least one of a wireless personal area network, a wireless local area network, a wireless metropolitan area network, or a wireless wide area network.

10. An article of manufacture as defined in claim 8, wherein the content, when accessed, causes the machine to store the one or more packets by storing each of the one or more packets in at least one of the first storage device or the second storage device based on a queue mapping table.

11. An article of manufacture as defined in claim 8, wherein the content, when accessed, causes the machine to store the one or more packets by storing each of the one or more packets in a queue based on at least one of a traffic type or a traffic priority.

12. An article of manufacture as defined in claim 8, wherein the content, when accessed, causes the machine to generate the schedule by generating a schedule to transmit each of the one or more packets based on at least one of a traffic type or a traffic priority.

13. An article of manufacture as defined in claim 8, wherein the content, when accessed, causes the machine to control the network interface device based on a condition associated with at least one of the first storage device or the second storage device.

14. An article of manufacture as defined in claim 8, wherein the content, when accessed, causes the machine to monitor the first and second storage devices and adjust the network interface device to a power save mode in response to detecting a condition indicative of the first and second storage devices being empty.

15. An apparatus comprising:
a packet identifier to identify one or more packets from at least one of a first device driver or a second device driver of a platform and to store the one or more packets in at least one of a first storage device or a second storage device, the first and second device drivers operating in accordance with different wireless communication protocols and sharing resources of a platform, the first storage device being associated with the first device driver and the second storage device being associated with the second device driver; and
a transmission scheduler operatively coupled to the first and second storage devices to schedule transmission of the one or more packets via a network interface device of the platform.

16. An apparatus as defined in claim 15, wherein the one or more packets comprises a packet from a device driver operating in accordance with a wireless communication protocol associated with at least one of a wireless personal area network, a wireless local area network, a wireless metropolitan area network, or a wireless wide area network.

17. An apparatus as defined in claim 15, wherein the packet identifier comprises a queue mapping table.

18. An apparatus as defined in claim 15, wherein each of the first and second storage devices comprises a plurality of queues, each of the plurality of queues being associated with at least one of a traffic type or a traffic priority.

19. An apparatus as defined in claim 15, wherein the transmission scheduler is configured to schedule the transmission of each of the one or more packets based on at least one of a traffic type or a traffic priority.

20. An apparatus as defined in claim 15 further comprising a network interface device controller operatively coupled to the transmission scheduler to control the network interface device based on a condition associated with at least one of the first storage device or the second storage device.

21. An apparatus as defined in claim 15 further comprising a network interface device controller operatively coupled to the transmission scheduler to monitor the first and second storage devices and to adjust the network interface device to a power save mode in response to detecting a condition indicative of the first and second storage devices being empty.

22. A system comprising:
a network interface device operatively coupled to an omni-directional antenna; and
a processor operatively coupled to the network interface device to associate one or more packets from a first device driver or a second device driver with at least one of a first storage device or a second storage device, and to schedule transmission of the one or more packets via the network interface device of the platform,
wherein the first and second device drivers operate in accordance with different wireless communication protocols and share resources of a platform, the first storage device is associated with the first device driver, and the second storage device is associated with the second device driver.

23. A system as defined in claim 22, wherein the processor is configured to store a packet from a device driver operating in accordance with a wireless communication protocol associated with at least one of a wireless personal area network, a wireless local area network, a wireless metropolitan area network, or a wireless wide area network.

24. A system as defined in claim 22, wherein the processor is configured to store each of the one or more packets in at least one of the first storage device or the second storage device based on a queue mapping table.

25. A system as defined in claim 22, wherein the processor is configured to store each of the one or more packets in a queue based on at least one of a traffic type or a traffic priority.

26. A system as defined in claim 22, wherein the processor is configured to schedule the transmission of each of the one or more packets based on at least one of a traffic type or a traffic priority.

27. A system as defined in claim 22, wherein the processor is configured to control the network interface device based on a condition associated with at least one of the first storage device or the second storage device.

28. A system as defined in claim 22, wherein the processor is configured to monitor the first and second storage devices and adjust the network interface device to a power save mode in response to detecting a condition indicative of the first and second storage devices being empty.
